(19) United States
(12) Patent Application Publication
(10) Pub. No.: US 2019/0262714 A1
(43) Pub. Date: Aug. 29, 2019

(54) GAME SYSTEM AND METHOD FOR CONTROLLING GAME SYSTEM

(71) Applicant: CAPCOM CO., LTD., Osaka (JP)

(72) Inventors: Yuya TOKUDA, Osaka (JP); Teruki ENDO, OSAKA (JP); Koji TOMINAGA, OSAKA (JP); Yuichi SAKATANI, OSAKA (JP)

(73) Assignee: CAPCOM CO., LTD., OSAKA (JP)

(21) Appl. No.: 16/343,863

(22) PCT Filed: Oct. 30, 2017
(86) PCT No.: PCT/JP2017/039159

§ 371 Date: Apr. 22, 2019

(30) Foreign Application Priority Data
Oct. 31, 2016 (JP) 2016-213570
Oct. 31, 2016 (JP) 2016-213571

(51) Int. Cl. A63F 13/56; A63F 13/57; A63F 13/822

(52) U.S. Cl. CPC A63F 13/56; A63F 13/822; A63F 13/57

(57) ABSTRACT

The game system includes a storage unit and a control unit. The control unit includes: a virtual space generating unit that generates a virtual space; a first character control unit that controls action of a first character moving in the virtual space; a second character control unit that controls action of a second character moving in the virtual space; a trace position storing unit that sequentially stores, in the storage unit, positions of the first character in the virtual space as trace positions at predetermined time intervals; and a chase processing unit that executes chasing of the first character by the second character based on the trace positions stored in the storage unit.

### TECHNICAL FIELD

The present invention relates to a game system that implements a game in which a plurality of characters acting in a virtual space appear, and a method for controlling a game system.

### BACKGROUND ART

In the related art, games in which a plurality of characters acting in a virtual space appear and in which a specific character chases another character are proposed. In this kind of game, chasing modes of a chasing character may be changed depending on whether the chasing character is visually recognizing a chased character.

For example, Patent Literature 1 discloses a game in which a player character (hereinafter, also referred to as “PC”) acting in accordance with actions of a player and a non-player character (hereinafter, also referred to as “NPC”) appear in a virtual game space. In this game, it is disclosed that a monster, which is an NPC, has vision- and olfaction-related enemy searching ability. Whether the vision of the monster is usable is determined and, if the vision is usable, the monster chases the PC with the vision. If the vision is not usable, the monster chases the PC with olfaction.

### CITATION LIST

### Patent Literature

Patent Literature 1: Japanese Laid-Open Patent Application Publication No. 2003-175281

### SUMMARY OF THE INVENTION

### Problems to be Solved by the Invention

However, Patent Literature 1 does not specifically describe how the monster, which is a chasing character, will chase the PC with olfaction when the monster is not recognizing a position of the PC. Therefore, a chasing action of the chasing character with olfaction cannot be expressed with reality from the disclosure of Patent Literature 1.

Accordingly, an object of the invention is to provide a game system capable of imparting reality to chasing when the chasing character is not recognizing a position of a chased character, and a method for controlling a game system.

### Means for Solving the Problems

A game system according to an aspect of the invention is a game system including a storage unit and a control unit, wherein the control unit includes: a virtual space generating unit that generates a virtual space; a first character control unit that controls action of a first character moving in the virtual space; a second character control unit that controls action of a second character moving in the virtual space; a trace position storing unit that sequentially stores, in the storage unit, positions of the first character in the virtual space as trace positions at predetermined time intervals; and a chase processing unit that executes chasing of the first character by the second character based on the trace positions stored in the storage unit.

### Effect of the Invention

According to the invention, a game system capable of imparting reality to chasing when the chasing character is not recognizing a position of a chased character, and a method for controlling a game system can be provided.

### BRIEF DESCRIPTION OF THE DRAWINGS

FIG. 1 is a block diagram illustrating a hardware configuration of a game system according to an embodiment.

FIG. 2A is a schematic diagram illustrating a game situation when an enemy character is in a normal state.

FIG. 2B is a schematic diagram illustrating a game situation when the enemy character is in the normal state.

FIG. 3A is a schematic diagram illustrating a game situation when the enemy character is in a position recognized state.

FIG. 3B is a schematic diagram illustrating a game situation when the enemy character is in the position recognized state.

FIG. 4A is a schematic diagram illustrating a game situation when the enemy character is in a lost-sight state.

FIG. 4B is a schematic diagram illustrating a game situation when the enemy character is in the lost-sight state.

FIG. 5A is a schematic diagram illustrating a game situation when the enemy character in the lost-sight state is chasing a player character.

FIG. 5B is a schematic diagram illustrating a game situation when the enemy character in the lost-sight state is chasing the player character.

FIG. 6A is a schematic diagram illustrating a game situation when the enemy character rediscovers the player character.

FIG. 6B is a schematic diagram illustrating a game situation when the enemy character rediscovers the player character.

FIG. 7 is a block diagram illustrating a functional configuration of the game device illustrated in FIG. 1.

FIG. 8 is a flowchart illustrating a flow of a state change process.

FIG. 9A is a diagram illustrating a chasing action of an NPC.

FIG. 9B is a diagram illustrating a chasing action of the NPC.

FIG. 10A is a diagram illustrating a chasing action of the NPC when no predetermined trace position is present in a search range.

FIG. 10B is a diagram illustrating a chasing action of the NPC when no predetermined trace position is present in the search range.

FIG. 11 is a flowchart illustrating a flow of a chase process.

### DETAILED DESCRIPTION OF THE INVENTION

A game system according to one aspect of the invention is game system including a storage unit and a control unit, wherein the control unit includes: a virtual space generating unit that generates a virtual space; a first character control unit that controls action of a first character moving in the virtual space; a second character control unit that controls action of a second character moving in the virtual space; a trace position storing unit that sequentially stores, in the storage unit, positions of the first character in the virtual space as trace positions at predetermined time intervals; and a chase processing unit that executes chasing of the first character by the second character based on the trace positions stored in the storage unit.

With this configuration, the second character, which is the chasing character, chases the first character, which is the chased character, based on the trace positions. Therefore, reality can be imparted to chasing by the second character not recognizing the position of the first character.

The trace position storing unit may store, in the storage unit, the trace positions and times at which the trace positions are stored in association with each other; an upper limit may be set for the number of the trace positions stored in the storage unit; and when the most recent trace position is to be stored in a state in which the number of already stored trace positions has reached the upper limit, the trace position storing unit may delete the trace position stored earliest among the trace positions stored in the storage unit. Therefore, capacity occupied by the trace position data in the storage unit can be saved.

Alternatively, the trace position storing unit may store, in the storage unit, the trace positions and times at which the trace positions are stored in association with each other; and the trace position storing unit may delete, from the storage unit, a trace position that has been stored in the storage unit for a certain time. Therefore, capacity occupied by the trace position data in the storage unit can be saved.

the control unit may include a state change processing unit that changes a state of the second character between a position recognized state in which the second character recognizes a position of the first character and a lost-sight state in which the second character does not recognize a position of the first character; and when the state of the second character is changed from the position recognized state to the lost-sight state, the chase processing unit may execute chasing of the first character by the second character based on the trace positions. Thus, even when the second character which is the chasing character loses sight of the first character which is the chased character, it is possible to give the user a feeling of tension to be chased by the second character.

The chase processing unit may include a trace position specifying unit that specifies a most recently stored trace position as a target position from among the trace positions in a predetermined search range including the second character; and the chase processing unit may execute chasing of the first character by the second character by alternately repeating specifying of the trace position and movement of the second character to the specified target position. Therefore, since one piece of trace data is specified from among trace data in the search range and then the position to move next is determined, a chasing route of the second character can be changed depending on the length of the time interval of storing the trace data and the size of the range in which the second character searches.

When the trace position in the search range is not present in the trace positions stored in the storage unit, the trace position specifying unit may specify, as the target position, a predetermined trace position stored before the state is changed to the lost-sight state from among the trace positions outside the search range. Thus, even if the next destination of the second character which is the chasing character is not found in the search range, a destination of the second character is found outside the search range. Therefore, chasing by the second character is continued.

In a case in which, after the second character is moved to the specified trace position, the trace position stored more recently than the trace position to which the second character is moved is not present in the search range, the trace position specifying unit may specify, as the target position, a trace position stored next recent to the previously specified trace position outside the search range. Thus, even if the next destination of the second character which is the chasing character is not found in the search range, a destination of the second character is found outside the search range. Therefore, chasing by the second character is continued.

A game system according to another aspect of the invention includes: a virtual space generating unit that generates a virtual space in which a plurality of objects are arranged; a player character (hereinafter, “PC”) control unit that controls action of a PC moving in the virtual space in response to a user operation; a non-player character (hereinafter, “NPC”) control unit that controls action of a NPC that is a character other than the PC and moving in the virtual space; and a lost-sight state change determining unit that determines to change a state of the NPC from a position recognized state in which the NPC is recognizing a position of the PC to a lost-sight state in which the NPC does not recognize a position of the PC when an imaginary line segment connecting the NPC and the PC in the virtual space touches or intersects a specific object among the plurality of objects.

Therefore, when the imaginary line segment connecting the NPC and the PC touches or intersects the specific object, since the PC is located in a position hidden from the NPC by the specific object, the lost-sight state can be produced without causing a user to feel unnaturality.

When the NPC is in the position recognized state, if the imaginary line segment does not touch or intersect the specific object, the lost-sight state change determining unit may keep the NPC in the position recognized state. Even when the PC is not in the field of view of the NPC, when the imaginary line segment connecting the NPC and the PC does not touch or intersect the specific object, the state of the NPC is not changed from the position recognized state to the lost-sight state. Thus, it is possible to prevent frequent occurrence of lost-sight state during a battle between the PC and the NPC.

A lost-sight state release determining unit that, when the PC enters a field of view of the NPC, that releases the lost-sight state of the NPC, and determines to change the state of the NPC from the lost-sight state to the position recognized state may be provided. With this configuration, reality can be imparted to a situation in which the NPC rediscovers the PC in the virtual space.

A method for controlling a game system according to one aspect of the invention includes: a virtual space generating step of generating a virtual space; a first character controlling step of controlling action of a first character moving in the virtual space; a second character controlling step of controlling action of a second character moving in the virtual space; a trace position storing step of sequentially storing, in the storage unit, positions of the first character in the virtual space as trace positions at predetermined time intervals; and a chase processing step of executing chasing the first character by the second character based on the trace positions stored in the storage unit.

Below, a game system and a method for controlling a game system according to an embodiment of the invention will be described with reference to the drawings.

### [Hardware Configuration]

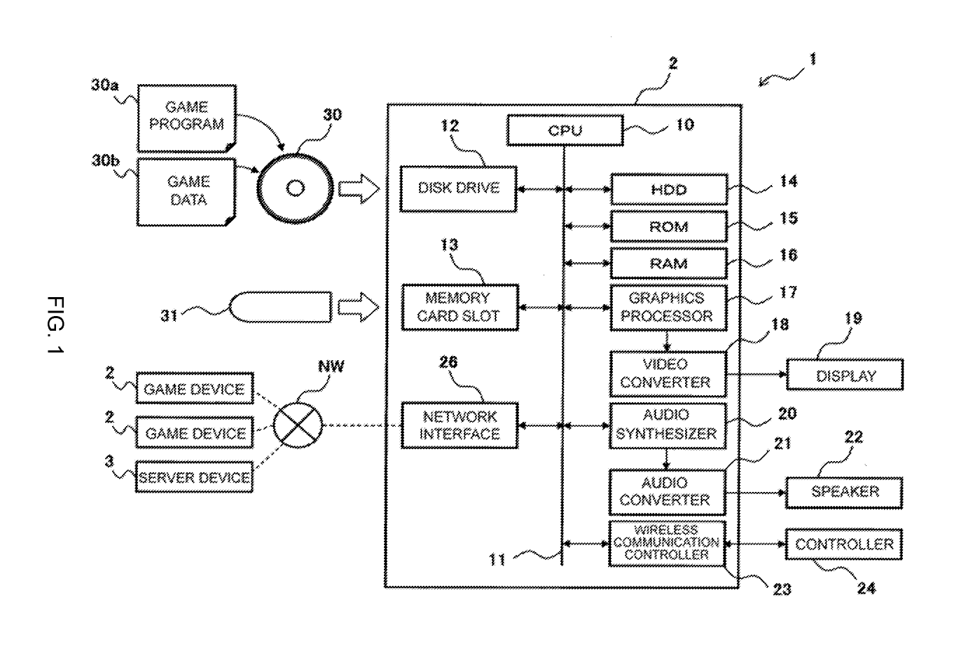

FIG. 1 is a block diagram illustrating a hardware configuration of a game system 1. The game system 1 includes a game device 2 and a server device 3. The game device 2 can communicate with other game devices 2 and the server device 3 via a communication network NW, such as the Internet or a local area network (LAN). The game device 2 includes a central processing unit (CPU) 10 that is a computer controlling an operation of the game device 2. The CPU 10 is an example of a control unit of the invention. A disk drive 12, a memory card slot 13, a hard disk drive(HDD) 14, read only memory (ROM) 15, and random-access memory (RAM) 16 that form a storage unit (program storage unit) are connected to the CPU 10 via a bus 11.

A disc-shaped recording medium 30, such as digital versatile disc (DVD)-ROM, is loadable in the disk drive 12. The disc-shaped recording medium 30 is an example of a nonvolatile recording medium according to the invention. A game program 30a and game data 30b according to the present embodiment are recorded on the recording medium 30. The game data 30b includes various types of data necessary for the progress of the game, such as data necessary to form each character and a virtual space, and sound data to be reproduced in the game. A card-shaped recording medium 31 is loadable in the memory card slot 13. Saved data indicating a playing situation, such as a progress of the game, can be recorded on the recording medium 31 according to an instruction from the CPU 10.

The HDD 14 is a large-capacity recording medium built in the game device 2. The game program 30a and the game data 30b read from the disc-shaped recording medium 30, save data, etc. are recorded in the HDD 14. The ROM 15 is semiconductor memory, such as mask ROM or programmable ROM (PROM), in which a startup program for starting up the game device 2, a program for controlling an operation when the disc-shaped recording medium 30 is loaded, etc. are recorded. The RAM 16 is formed by dynamic random-access memory (DRAM), static random-access memory (SRAM), etc. The RAM 16 reads the game program 30a to be executed by the CPU 10, the game data 30b necessary for the execution of the game program 30a, etc. from the disc-shaped recording medium 30 or the HDD 14 in accordance with a play situation of the game and temporarily records.

A graphics processor 17, an audio synthesizer 20, a wireless communication controller 23, and a network interface 26 are also connected to the CPU 10 via the bus 11.

Among these components, the graphics processor 17 draws a game image including a virtual game space, each character, etc. according to an instruction from the CPU 10. That is, the graphics processor 17 adjusts position, direction, zoom (angle of view), etc. of a virtual camera set in the virtual space, and captures images of the virtual space. The graphics processor 17 renders the captured image and generates a two-dimensional game image for display. An external display (display unit) 19 is connected to the graphics processor 17 via a video converter 18. The game image drawn by the graphics processor 17 is converted into a moving image format by the video converter 18 and displayed on the display 19.

According to an instruction from the CPU 10, the audio synthesizer 20 reproduces and synthesizes digital sound data included in the game data 30b. An external speaker 22 is connected to the audio synthesizer 20 via an audio converter 21. Thus, the sound data reproduced and synthesized by the audio synthesizer 20 is decoded into an analog form by the audio converter 21 and output from the speaker 22 to the outside. Therefore, a user playing the game can hear the reproduced sound.

The wireless communication controller 23 has a wireless communication module in 2.4 GHz band, and is wirelessly connected to a controller 24 attached to the game device 2. Therefore, transmission and reception of data are possible. The user can input a signal in the game device 2 by operating an operating unit, such as a button, provided in the controller 24, and controls an action of the player character displayed on the display 19.

The network interface 26 connects the game device 2 to a communication network NW, such as the Internet or a LAN, and enables the game device 2 to communicate with other game devices 2 and the server device 3. The network interface 26 connects the game device 2 to other game devices 2 via the communication network NW to transmit and receive data to and from each other, so that a plurality of player characters can be displayed synchronously in the same virtual space. This configuration enables a multiplayer game in which a plurality of players cooperatively proceeds a game.

### [Outline of Game]

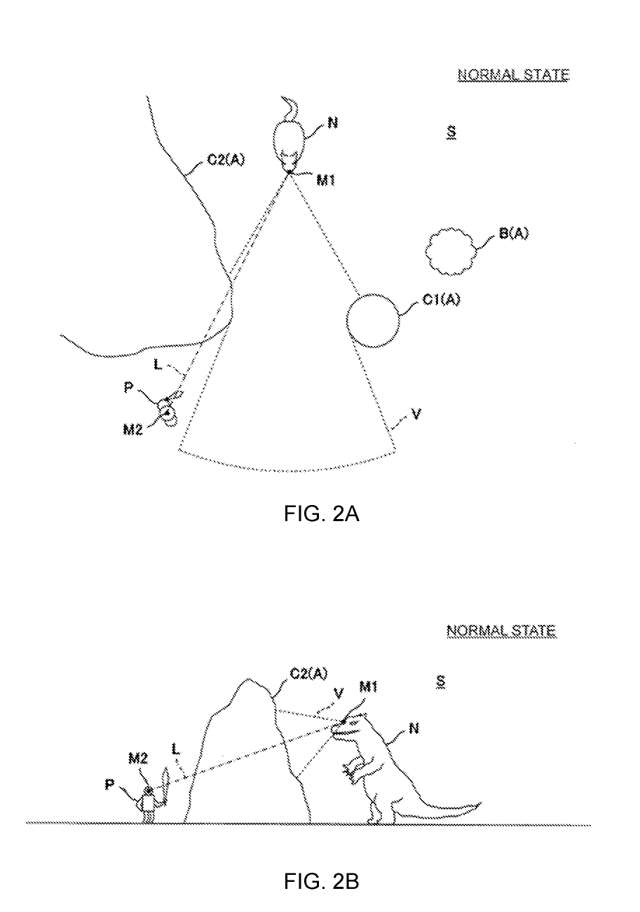

Next, with reference to FIGS. 2A to 6B, an outline of a game implemented by the game program 30a executed by the game device 2 illustrated in FIG. 1 will be described.

FIGS. 2A, 3A, 4A, 5A, and 6A are schematic plan views of a virtual space S when viewed from above. FIGS. 2B, 3B, 4B, 5B, and 6B are schematic plan views of the virtual space S when viewed from a side. FIGS. 2B, 3B, 4B, 5B, and 6B are views of the virtual space S viewed from a direction orthogonal to a vertical plane through a player character P and an enemy character N.

As illustrated in FIGS. 2A to 6B, in this game, the virtual space S having a predetermined width is set. In the virtual space S, the player character P of which action is directly controllable by the user via an operation by using the controller 24 is present. In the same virtual space S, the enemy character N, such as a monster, which is a non-player character (NPC) of which action cannot be directly controlled by an operation of the user but is controlled by the CPU 10 is also present. A virtual camera (not illustrated) for capturing an image of the virtual space S is disposed in a predetermined position in the virtual space S near the player character P. On the display 19 of the game device 2, the image of the virtual space S captured by the virtual camera is displayed. This game is an action game in which the user battles with the enemy character N and destroys the enemy character N by operating the player character P while watching the virtual space S displayed on the display 19. In FIG. 2A to FIG. 6B, an imaginary line segment L connecting the enemy character N and the player character P is indicated by a dashed line.

In this game, as illustrated in FIGS. 2A, 3A, 4A, 5A and 6A, various objects A, such as a rock and a tree, are suitably arranged in the virtual space S. Note that three objects A (B, C1, and C2) are present in the example illustrated in FIGS. 2A, 3A, 4A, 5A and 6A. The object B is a bush, the object C1 is a tree, and the object C2 is a rock.

Further, as indicated by a broken line in FIG. 2A to FIG. 6B, an area extending in a predetermined direction from the enemy character N in the virtual space S is defined as a field of view V of the enemy character N. In the present embodiment, an area extending in a conical shape (e.g., cone, pyramid) from a predetermined point M1 positioned at the head of the enemy character N toward a direction the head of the enemy character N faces is defined as the field of view of the enemy character N. Further, as illustrated in FIG. 2A to FIG. 6B, the field of view V of the enemy character N is blocked by the object A. That is, the enemy character N cannot see the back side of the object A as viewed from the enemy character N.

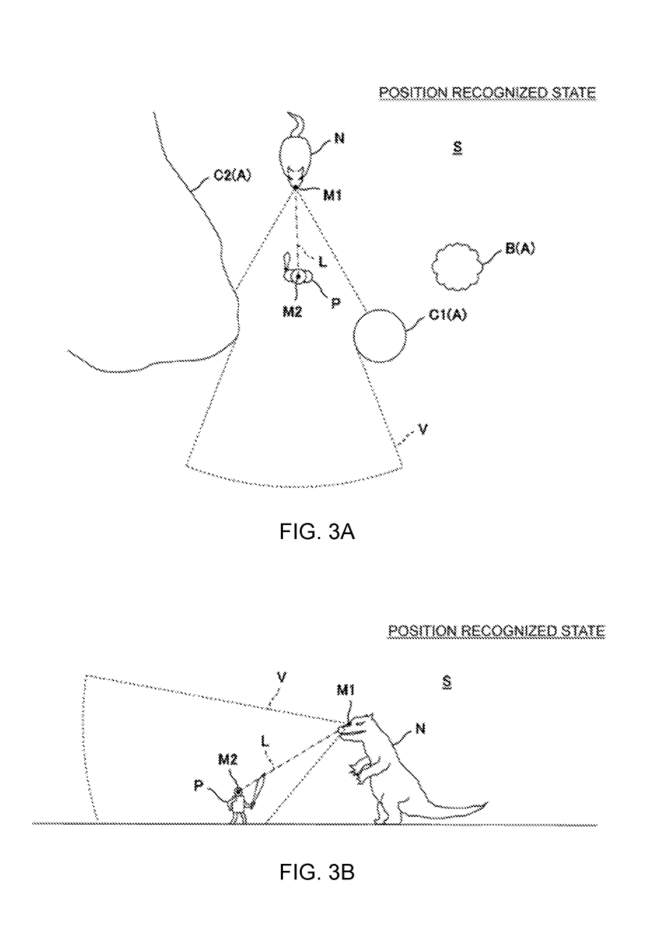

The enemy character N changes its behavior before and after discovering the player character P. FIG. 2A and FIG. 2B illustrate a situation in which the enemy character N has not discovered the player character P. FIG. 3A and FIG. 3B illustrate a situation in which the enemy character N has discovered the player character P. As illustrated in FIG. 2A and FIG. 2B, when the enemy character N has not discovered the player character P (that is, before discovering the player character P), the enemy character N performs a normal action, such as walking and looking around (hereinafter, referred to as “normal state”).

As illustrated in FIG. 3A and FIG. 3B, when the player character P enters the field of view V of the enemy character N, the enemy character N becomes a state in which a position of the player character P is recognized (hereinafter, referred to as “position recognized state”). Upon recognizing the position of the player character P, the enemy character N takes battle action with respect to the player character P. Battle actions may include taking a posture to attack, and actually attacking. Thus, when the battle between the player character P and the enemy character N is started, the player character P destroys the enemy character N while, for example, avoiding the attack of the enemy character N, using weapons to attack the enemy character N to give damage, and adjusting a status of the player character P in the battle by using items or the like (e.g., restoration of sharpness of the weapon, and restoration of hit points of the player character P)in accordance with the operation of the user.

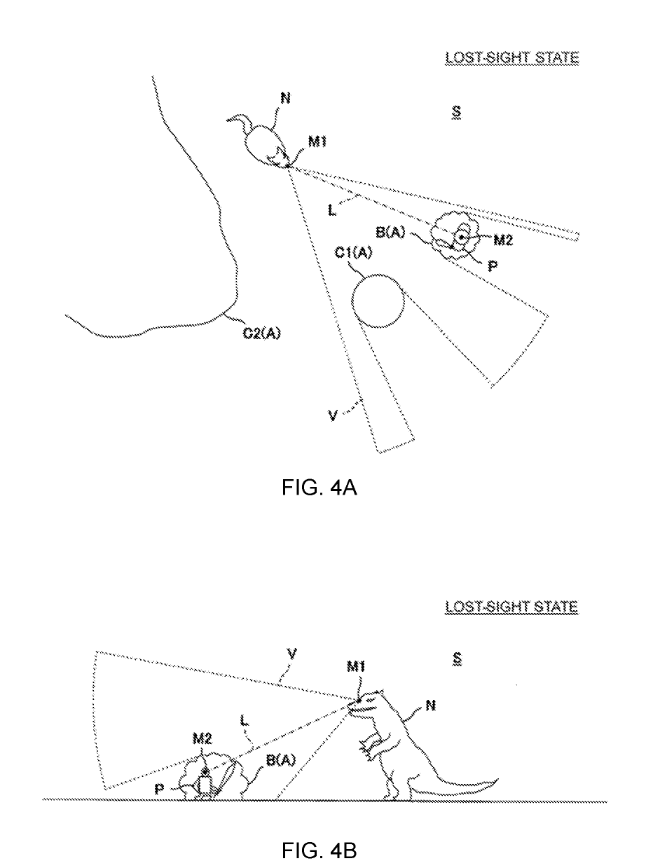

In this game, a situation in which the enemy character N has lost sight of the player character P occurs. FIG. 4A and FIG. 4B illustrate the situation in which the enemy character N has lost sight of the player character P. The object A placed in the virtual space S includes a specific object B that causes a situation in which the enemy character N loses sight of the player character P, and general objects C1 and C2 which do not cause a situation in which the enemy character N loses sight of the player character P. When a relationship among the player character P, the enemy character N, and the specific object B satisfies a predetermined condition, a losing sight occurs, and the state of the enemy character N is changed from the position recognized state to a state in which the enemy character N has lost sight of the player character P (hereinafter, referred to as “lost-sight state”).

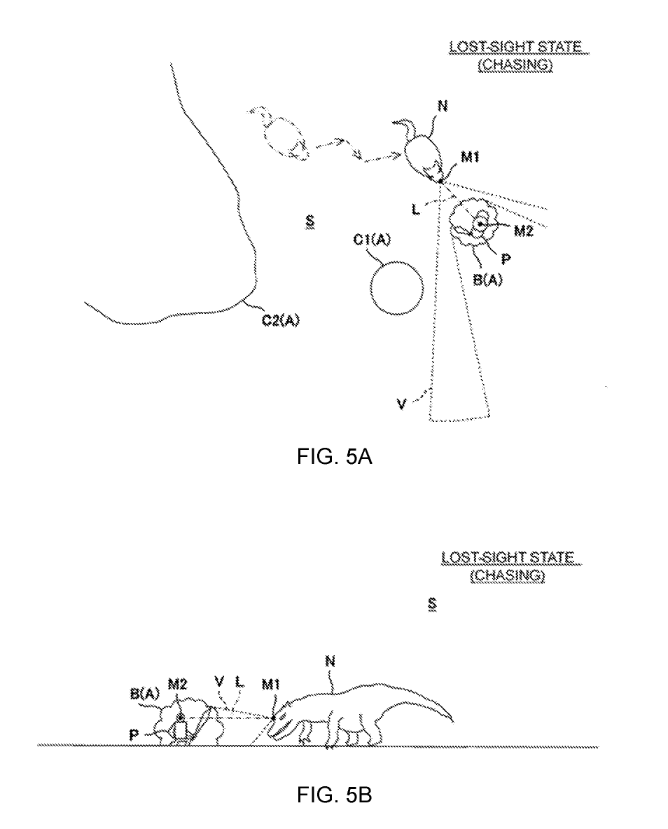

In this game, the enemy character N in the lost-sight state takes an action to chase the player character P. FIG. 5A and FIG. 5B illustrate a situation in which the enemy character N is chasing the player character P of which sight the enemy character N has lost. The enemy character N in the lost-sight state gradually approaches the player character P as indicated by an arrow of the two-dot chain line in FIG. 5A based on trace positions described later. While the enemy character N is in the lost-sight state, the player character P will not be attacked by the enemy character N. Therefore, while the enemy character N is in the lost-sight state, the user can cause the player character P to perform an action (e.g., use of an item) allowing the enemy character N to attack the player character P.

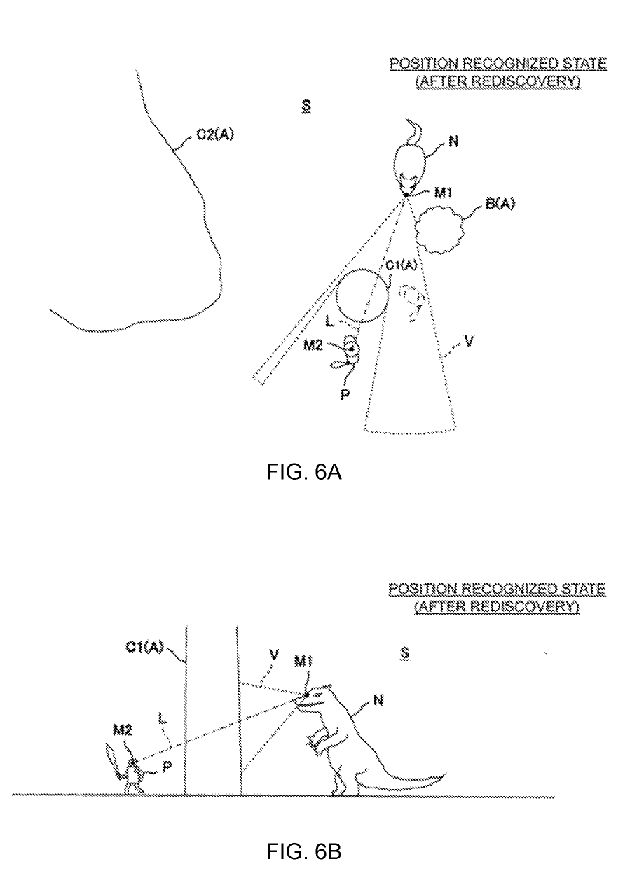

FIG. 6A and FIG. 6B illustrate a situation in which the enemy character N rediscovers the player character P. When the player character P enters the field of view V of the enemy character N again as illustrated by the two-dot chain line in FIG. 6A and FIG. 6B, the lost-sight state of the enemy character N is released. Therefore, the state of the enemy character N is changed from the lost-sight state to the position recognized state, and the enemy character N stops the chasing action and takes a battle action. Thereafter, as long as the state of the enemy character N is not changed to the lost-sight state again, the position recognized state is kept and the enemy character N continues the battle action or takes an escape action. For example, as illustrated in FIG. 6A and FIG. 6B, even if the player character P hides behind the general object C1 after the enemy character N rediscovers the player character P, losing sight does not occur and the enemy character N continues the battle action.

### [Functional Configuration of Game Device]

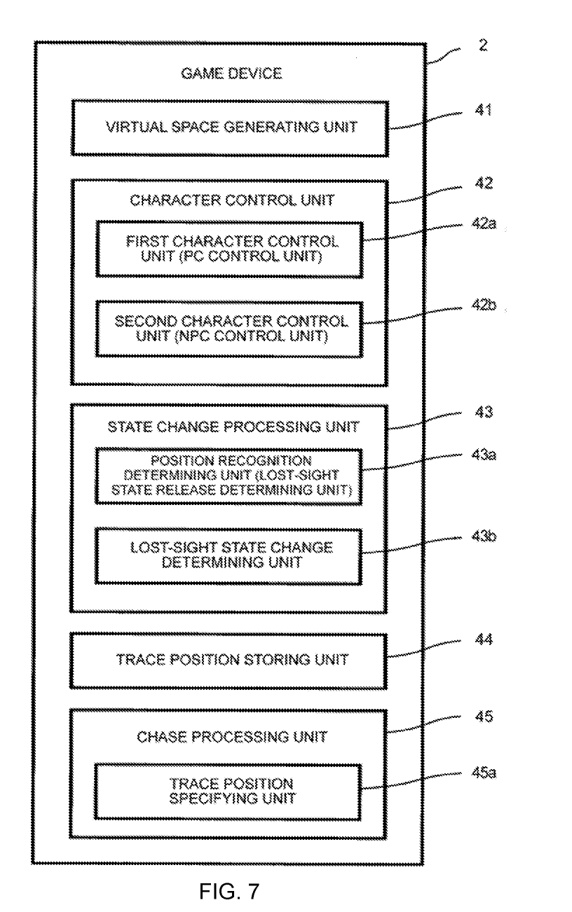

FIG. 7 is a block diagram illustrating a functional configuration of the game device 2 provided in the game system 1. The game device 2 executes the game program 30a of the invention to function as a virtual space generating unit (virtual space generating means) 41, a character control unit (character control means) 42, a state change processing unit (state change processing means) 43, a trace position storing unit (trace position storing means) 44, and a chase processing unit (chase processing means) 45. Note that each of these functions is formed by, as hardware, the CPU 10, the HDD 14, the ROM 15, the RAM 16, the graphics processor 17, the video converter 18, the audio synthesizer 20, the audio converter 21, the wireless communication controller 23, etc., as illustrated in FIG. 1.

The virtual space generating unit 41 generates a three-dimensional virtual space S. In the virtual space S, a specific character chases another character. As described above, in the virtual space S, the player character P is present as a first character which is the chased character, and the enemy character N is present as a second character which is the chasing character. NPCs other than the enemy character N also present in the virtual space S in addition to the player character P and the enemy character N. NPCs other than the enemy character N may include, for example, characters which attack the enemy character cooperatively with the player character P or villagers who are neither ally nor enemies. Further, the virtual space generating unit 41 generates the object A described above and places the object A in the virtual space S. As described above, the object A may include the specific object B and the general objects C1 and C2. In the present embodiment, the specific object B is generated to include an internal space which the player character P can enter. However, the specific object B does not necessarily have to include an internal space which the player character P can enter.

The character control unit 42 includes a first character control unit (first character control means) 42a that controls action of the first character which is the chased character, and a second character control unit (second character control means) 42b that controls action of the second character, which is the chasing character. In the present embodiment, the first character control unit 42a functions as a player character control unit (player character control means) 42a that controls action of the player character P in the virtual space S in response to a user's operation. Hereinafter, the player character control unit will be referred to as a PC control unit. The PC control unit 42a controls various types of action including movement, attack, defense, use of items, and the like of the player character P during the battle in response to, for example, the user operation of the controller 24. Further, in the present embodiment, the second character control unit 42b functions as a non-player character control unit (non-player character control means) 42b that controls action of the NPC in the virtual space S. Hereinafter, the non-player character control unit will be referred to as an NPC control unit. For example, the NPC control unit 42b controls various types of action, such as movement, attack, and defense, of the enemy character N fighting against the player character P. The NPC control unit 42b also controls action of NPCs other than the enemy character N that fight against the player character P.

The state change processing unit 43 processes the state change of the enemy character N. In the present embodiment, the state change processing unit 43 changes the state of the enemy character N among the normal state described above in which the enemy character N takes normal action (FIGS. 2A and 2B), the position recognized state in which the enemy character N takes battle action (FIGS. 3A, 3B, 6A, and 6B), and the lost-sight state in which the enemy character N takes chasing action (FIGS. 4A, 4B, 5A, and 5B). The state change processing unit 43 includes a position recognition determining unit (position recognition determining means) 43a and a lost-sight state change determining unit (lost-sight state change determining means) 43b.

When the enemy character N is not in the position recognized state (e.g., in the normal state or in the lost-sight state), the position recognition determining unit 43a determines whether the player character P is in the field of view V of the enemy character N (field of view determination).

Further, when the player character P enters the field of view V of the enemy character N, the position recognition determining unit 43a determines to change the state of the enemy character N from the current state to the position recognized state. In the present embodiment, when the player character P enters the field of view V of the enemy character N, the state of the enemy character N is changed from the current state to the position recognized state. However, the current state may be changed to the position recognized state when the state in which the player character P is in the field of view V of the enemy character N is continued for a predetermined time. When the current state of the enemy character N is the lost-sight state, the position recognition determining unit 43a functions as a lost-sight state release determining unit (lost-sight state release determining means) that releases the lost-sight state.

The lost-sight state change determining unit 43b determines whether the imaginary line segment L connecting the enemy character N and the player character P in the virtual space S touches or intersects the specific object B (ray determination). The imaginary line segment L is not actually displayed on the display 19 but is a line segment calculated from position information of a predetermined point M1 positioned in the enemy character N and a predetermined point M2 positioned in the player character P. In the examples illustrated in FIGS. 2A to 6B, the imaginary line segment L connects the predetermined point M1 positioned at the head of the enemy character N and the predetermined point M2 positioned at the head of the player character P. However, the imaginary line segment L is not limited to the same. For example, the imaginary line segment L may connect a specific point inside the body of the enemy character N and a specific point inside the body of the player character P.

Determination as to whether the imaginary line segment L touches or intersects the specific object B may be made in any way. For example, whether a straight line (ray) extending from the point M1 to the point M2 touches or intersects the object A may be determined, or whether a straight line (ray) extending from the point M2 to the point M1 touches or intersects the specific object B may be determined. In the present embodiment, the specific object B includes an internal space which the player character P can enter. Therefore, when the player character P enters the specific object B, the imaginary line segment L between the player character P inside the specific object B and the enemy character N outside the specific object B reliably intersects the specific object B.

Further, when the imaginary line segment L touches or intersects the specific object B, the lost-sight state change determining unit 43b determines to change the state of the enemy character N from the position recognized state to the lost-sight state. When the imaginary line segment L does not touch or intersect the specific object B, the lost-sight state change determining unit 43b keeps the enemy character N in the position recognized state. In the present embodiment, when a state in which the imaginary line segment L is touching or intersecting the specific object B is continued for a predetermined time, the state of the enemy character N is changed from the position recognized state to the lost-sight state. However, when the imaginary line segment L touches or intersects the specific object B, the state of the enemy character N may be changed from the position recognized state to the lost-sight state. Further, conditions for changing to the lost-sight state may include conditions other than that the imaginary line segment L touches or intersects the specific object B. For example, conditions for changing to the lost-sight state may include conditions that the player character P takes specific action, such as entering the internal space of the object B, the player character P takes a specific posture, such as squatting on that spot, etc.

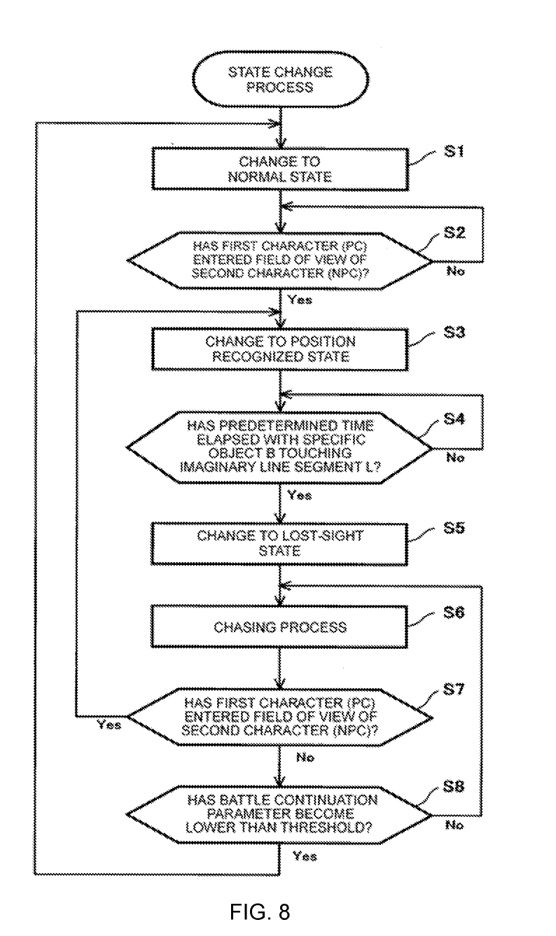

Here, a state change process by the state change processing unit 43 will be described with reference to a flowchart illustrated in FIG. 8.

As illustrated in FIG. 8, in the state change process, the state change processing unit 43 initially sets the state of the enemy character N placed in the virtual space S to the normal state as the initial state (step S1, FIG. 2A and FIG. 2B). Then, the state change processing unit 43 determines whether the player character P has entered the field of view V of the enemy character N (step S2). When the player character P has not entered the field of view V of the enemy character N (step S2: No), the state change processing unit 43 keeps the normal state of the enemy character N. When the player character P has entered the field of view V of the enemy character N (step S2: Yes, see FIG. 3A and FIG. 3B), the state change processing unit 43 changes the state of the enemy character N from the normal state to the position recognized state (step S3).

When changed to the position recognized state, the state change processing unit 43 determines whether the state in which the imaginary line segment L is touching or intersecting the specific object B has continued for a predetermined time (step S4). If the state in which the imaginary line segment L is touching or intersecting the specific object B has continued for a predetermined time (step S4: Yes), the state change processing unit 43 changes the state of the enemy character N from the position recognized state to the lost-sight state (step S5, see FIGS. 4A and 4B). Otherwise (step S4: No), the position recognized state of the enemy character N is kept.

When changed to the lost-sight state, the chase processing unit 45 executes the chase process (see step S6, FIGS. 5A and 5B), and the enemy character N chases the player character P of which sight the enemy character N has lost. Details of the chase process will be described later.

While the chase process is executed, the state change processing unit 43 determines whether the player character P has entered the field of view V of the enemy character N which is in the lost-sight state (step S7). When the player character P enters the field of view V of the enemy character N which is in the lost-sight state (step S7: Yes, see FIGS. 6A and 6B), the state change processing unit 43 releases the lost-sight state of the enemy character N, and changes the state of the enemy character N to the position recognized state again (step S3).

When the player character P has not entered the field of view V of the enemy character N which is in the lost-sight state (step S7: No), the state change processing unit 43 determines whether a battle continuation parameter is lower than a threshold value (step S8). Here, the battle continuation parameter is a parameter for determining whether to continue the battle action or the chasing action of the enemy character N. The battle continuation parameter is managed by, for example, the state change processing unit 43 of the game device 2. In the present embodiment, while the enemy character N is in the lost-sight state, the battle continuation parameter gradually decreases as time elapses from the value when the battle continuation parameter changes to the lost-sight state. If the battle continuation parameter is not lower than the threshold value (step S8: No), the chase process is continued. If the battle continuation parameter is lower than the threshold value (step S8: Yes), the state of the enemy character N is changed from the lost-sight state to the normal state (step S1).

Returning to FIG. 7, the trace position storing unit 44 sequentially stores, in the storage unit, the positions (position data) of the player character P in the virtual space S as trace positions at predetermined time intervals. The trace positions are stored in association with stored order and stored time so that the stored order can be known. In the present embodiment, nothing is left in the trace position in the virtual space S, but the trace positions are stored in the form of coordinate data in the virtual space S. However, the game device 2 may actually leave objects representing traces, such as footprints and odors, of the player character P in or near the trace positions in the virtual space S at predetermined time intervals. In this case, the objects representing the trace may be transparent objects invisible from the user, or may be opaque objects (e.g., footprints or scratch marks).

In the present embodiment, the trace position storing unit 44 always stores the trace positions at predetermined time intervals while the player character P can move in the virtual space S, but this is not restrictive. For example, the trace positions may be stored at predetermined time intervals only when the enemy character N is in the position recognized state and in the lost-sight state.

In the present embodiment, an upper limit for the number of trace positions to be stored in the storage unit is set. When the most recent trace position is to be stored in a state in which the number of already stored trace positions has reached the upper limit, the trace position storing unit 44 deletes the trace position stored earliest among the trace positions stored in the storage unit. However, an upper limit for the number of trace positions stored in the storage unit does not necessarily have to be set. In this case, for example, the trace position storing unit 44 may delete, from the storage unit, a trace position that has been stored for a certain time.

When the state of the enemy character N is changed from the position recognized state to the lost-sight state, the chase processing unit 45 executes chasing of the player character P by the enemy character N based on the trace positions stored in the storage unit. The chase processing unit 45 includes a trace position specifying unit (trace position specifying means) 45a. The trace position specifying unit 45a specifies the most recently stored trace position, as the target position, from among the trace positions located in a predetermined search range R including the enemy character N. The search range R is, for example, a range within a predetermined distance from the enemy character N. The size of the search range R may be changed according to the type of the enemy character N. Alternatively, the size of the search range R may be changed for each specific process of the trace position by the trace position specifying unit 45a. For example, a plurality of types of actions of the enemy character N for specifying the trace position (e.g., a gesture of taking a smell of the ground) may be prepared in advance, and the size of the search range R may be changed according to the type of the action taken by the enemy character N. In this case, action of the enemy character N to specify the trace position may be selected by lottery, or may be selected based on the distance between the player character P and the enemy character N.

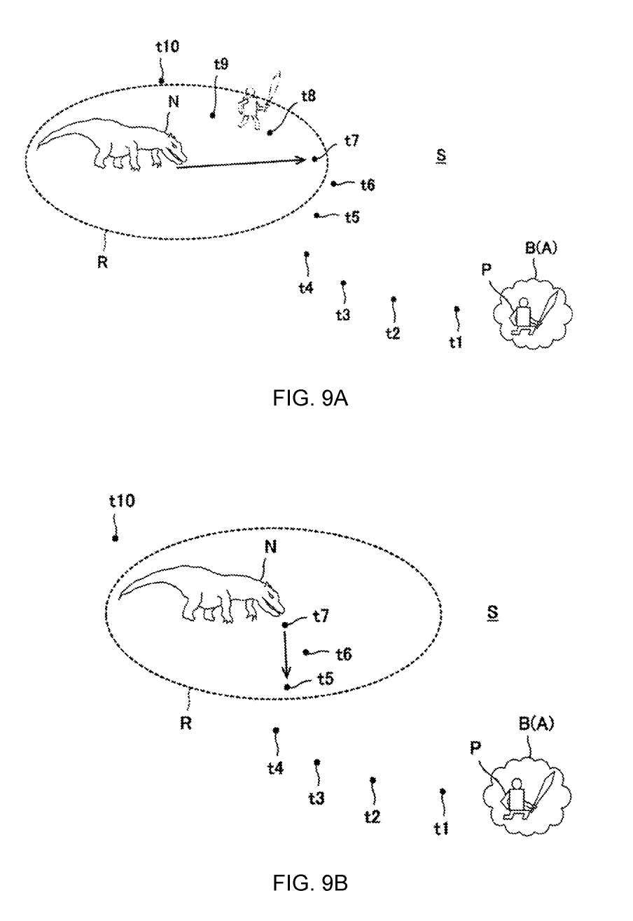

FIGS. 9A and 9B are diagrams illustrating a chasing action of the enemy character N when the virtual space S is viewed diagonally from above. As illustrated in FIGS. 9A and 9B, the player character P has entered the internal space of the specific object B. FIGS. 9A and 9B also illustrates trace positions t1 to t10 stored immediately before the player character P enters the specific object B. Note that t1 to t10 indicate that the smaller the numeral appended to the code t is, the more recently the trace position is stored. Further, in FIG. 9A and FIG. 9B, the search range R of the enemy character N is indicated by a broken line surrounding the enemy character N.

FIG. 9A illustrates a situation immediately after the enemy character N loses sight of the player character P, that is, immediately after the state of the enemy character N is changed from the position recognized state to a lost-sight state. In the situation illustrated in FIG. 9A, the trace position specifying unit 45a specifies the most recently stored trace position t7, as the target position, from among the three trace positions t7, t8, and t9 located in the search range R. Then, the chase processing unit 45 moves the enemy character N to the specified target position (trace position t7) as indicated by an arrow in FIG. 9A. At this time, the chase processing unit 45 may move the enemy character N linearly from the current position to the specified target position (trace position t7), or may move the enemy character N via other trace positions t8 and t9 detected in the search range R.

FIG. 9B illustrates a situation immediately after the enemy character N is moved to the trace position t7. Immediately after the enemy character N is moved to the trace position t7, the trace position specifying unit 45a specifies, as the target position, the most recently stored trace position t5 from among the trace positions t5, t6, t7 and the like in the search range R. Thus, the chase processing unit 45 alternately repeats specifying of the trace position and moving of the enemy character N to the specified target position. In this way, chasing of the player character P by the enemy character N is executed.

When the enemy character N arrives at the specific object B by the chase process, the chase processing unit 45 causes the enemy character N to perform predetermined action, such as looking into the specific object B, in order to put the player character P inside the specific object B into the field of view V. As a result, when the player character P enters the field of view V of the enemy character N, the lost-sight state of the enemy character N is released. Then, the state of the enemy character N is changed to the position recognized state again. When the player character P is not present inside the specific object B the enemy character N looked into, the chase processing unit 45 keeps the chasing action of the enemy character N. When the enemy character N arrives at the specific object B by the chase process, the specific object B at which the enemy character N arrived may be changed to a general object regarding which no losing-sight occurs.

Before the enemy character N arrives at the specific object B, the player character P may be moved out of the specific object B by the user's operation. In this case, unless the player character P enters the field of view V of the enemy character N, the chasing action of the enemy character N is continued.

When the lost-sight state of the enemy character N is released, the chasing action of the enemy character N by the chase processing unit 45 is ended. More specifically, when the player character P enters the field of view V of the enemy character N or when the above-described battle continuation parameter becomes lower than a threshold value, the chasing action of the enemy character N is ended.

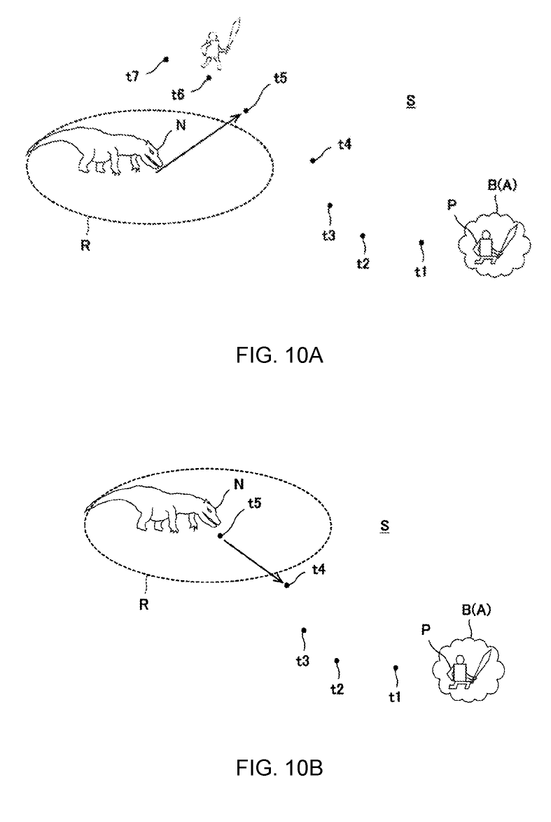

Next, with reference to FIG. 10A and FIG. 10B, a chasing action of the enemy character N in a situation different from the situation illustrated in FIGS. 9A and 9B will be described.

FIG. 10A is a diagram illustrating a chasing action of the enemy character N when no trace position is present in the search range R of the enemy character N. When there is no trace position located in the search range R in the trace positions stored in the storage unit, the trace position specifying unit 45a specifies, as the target position, a predetermined trace position stored before the state of the enemy character N is changed to the lost-sight state from among the trace positions outside the search range R. In the present embodiment, when there is no trace position indicating the positions in the search range R, the trace position specifying unit 45a specifies, as the target position, a trace position (trace position t5 in the example of FIG. 10A) stored predetermined times (in the example of FIG. 10A, five times) before the time at which the state of the enemy character N is changed to the lost-sight state.

However, the method for specifying the trace position when no trace position is present in the search range R is not limited to this. For example, when no trace position is present in the search range R, the trace position specifying unit 45a may specify, as the target position, the most recently stored trace position from among trace positions stored before a certain point of time predetermined time before the time at which the state of the enemy character N is changed to the lost-sight state. Further, the trace position specifying unit 45a may specify the trace position closest to the search range R as the target position, or may specify the trace position stored at the time of changing to the lost-sight state as the target position.

FIG. 10B is a diagram illustrating the chasing action of the enemy character N in a case in which, after the enemy character N is moved to the trace position, no trace position stored more recently than that trace position is present in the search range R. Note that FIG. 10B illustrates a situation immediately after the enemy character N is moved to the trace position t5 after the situation illustrated in FIG. 10A. As illustrated in FIG. 10B, after the enemy character N is moved to the trace position t5, if no trace position stored more recently than the trace position t5 is present in the search range R, the trace position specifying unit 45a specifies, as the target position, the trace position t4 stored next to the trace position t5 specified previous time outside the search range R.

However, the method for specifying the trace position in a case in which, after the enemy character N is moved to the trace position, no trace position stored more recently than that trace position is present in the search range R is not limited thereto. For example, the trace position specifying unit 45a may temporarily increase the search range R when the trace position stored more recently than the trace position t5 to which the enemy character N is moved is not present in the search range R. In this case, among the trace positions included in the increased search range R, the trace position specifying unit 45a may specify, as the target position, the trace position that is stored more recently than the trace position t5 and stored earliest excluding the trace position t5. Further, among the trace positions included in the increased search range R and stored more recently than the trace position t5, the trace position specifying unit 45a may specify, as the target position, a trace position located closest to the enemy character N excluding the trace position t5.

Alternatively, when the trace position stored more recently than the trace position t5 to which the enemy character N is moved is not present in the search range R, the trace position specifying unit 45a may move the enemy character N so as to search for the positions t1 to t4 stored more recently than the trace position t5 near the trace position t5 to which the enemy character N is moved. In this case, when the enemy character N is moved, the search range R is also moved, and then any of the trace positions t1 to t4 that are stored more recently enters the search range R, the trace position specifying unit 45a may specify, as the target position, the trace position that has entered the search range R. When the enemy character N is moved, the search range R is also moved, and then a plurality of the trace positions t1 to t4 that are stored more recently enter the search range R, the trace position specifying unit 45a may specify, as the target position, the trace position stored earliest from among the plurality of trace positions that have entered the search range R.

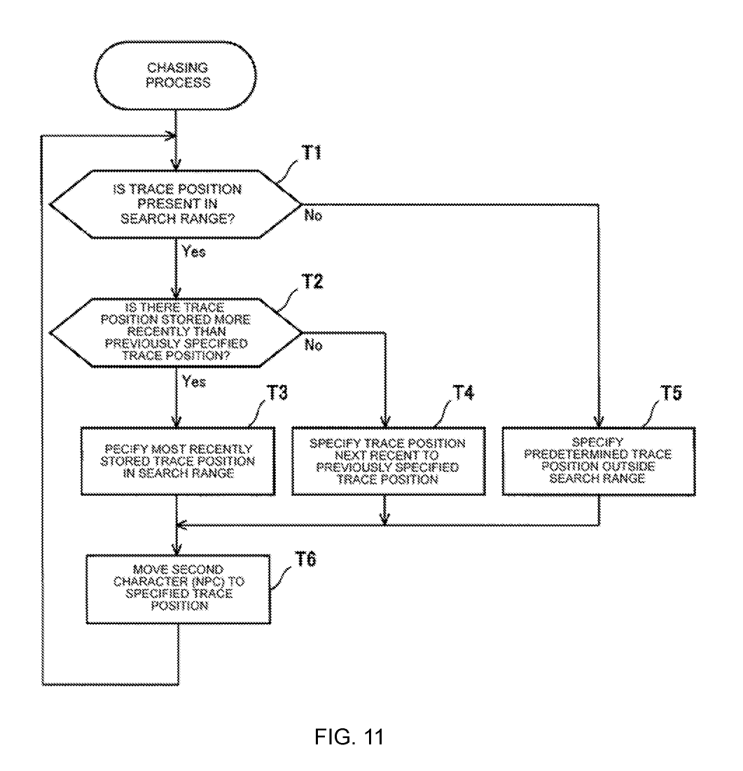

Next, the flow of the chase process illustrated in step S6 in FIG. 8 will be described with reference to FIG. 11. FIG. 11 is a flowchart illustrating the flow of the chase process by the chase processing unit 45.

As illustrated in FIG. 11, in the chase process, the chase processing unit 45 determines whether a trace position is present in the search range R of the enemy character N (step T1). When no trace position is present in the search range R (step T1: No), the chase processing unit 45 sets, as a target position, a predetermined trace position stored before the state of the enemy character N is changed to the lost-sight state from among the trace positions outside the search range R (step T5, see FIG. 10A).

When a trace position is present in the search range R (step T1: Yes), the chase processing unit 45 determines whether a trace position stored more recently than the previously specified trace position is present (step T2). When a trace position stored more recently than the previously specified trace position is present (step T2: Yes, see FIG. 9B), the chase processing unit 45 specifies, as the target position, the most recently stored trace from among the trace positions in the search range R (step T3). When no trace position stored more recently than the previously specified trace position is present (step T2: No, see FIG. 10B), the chase processing unit 45 specifies, as the target position, a trace position next recent to the previously specified trace position (step T4).

After specifying the trace position as the target position in steps T3, T4, and T5, the chase processing unit 45 moves the enemy character N to the specified target position (step T6). After moving the enemy character N, the chase processing unit 45 returns to the determination as to whether a trace position is present in the search range R (step T1). In this manner, the chase process is repeated while the enemy character N is in the lost-sight state (see steps S6 to S8 in FIG. 8).

As described above, in the game system 1 according to the present embodiment, since the chase processing unit 45 causes the enemy character N to chase the player character P based on the trace positions. Therefore, reality can be imparted to chasing by the enemy character N which is not recognizing the position of the player character P.

When the state of the enemy character N is changed from the position recognized state to the lost-sight state, the chase processing unit 45 causes the enemy character N to chase the player character P based on the trace positions. Therefore, even when the enemy character N loses sight of the player character P, it is possible to give the user a feeling of tension to be chased by the enemy character N.

In the related art, a game in which a certain range around an NPC, such as a monster, is set to be a field of view range of the NPC is proposed (for example, Japanese Laid-Open Patent Application Publication No. 2010-88675). In this type of game, when a PC enters the field of view of the NPC, a state of the NPC is changed from a normal state to a battle state. Then, as the PC is moved out of the field of view range of the NPC, the NPC loses sight of the PC. When a predetermined time elapses in that state, the state of the NPC is changed from the battle state to the normal state.

However, this type of lost-sight mode of the NPC may cause the user to feel unnaturality because the NPC loses sight of the PC when the PC goes out of a certain range around the NPC even if the NPC is visible from the PC. Conversely, if the PC enters a certain range around the NPC, the NPC does not lose sight of the PC even if the PC is not visible by the NPC, which may cause the user to feel unnaturality as well. Further, when the PC is located near a boundary of the certain range, a state in which the PC is discovered by the NPC and a state in which the NPC is lose sight of the PC are frequently switched when the PC is slightly moved. This may interrupt a battle condition frequently, making it difficult to effectively produce a battle scene that is the most enjoyable part of an action game.

In the present embodiment, when the imaginary line segment L connecting the enemy character N and the player character P touches or intersects the specific object B, the lost-sight state change determining unit 43b determines to change the state of the enemy character N from the position recognized state to the lost-sight state. When the imaginary line segment L touches or intersects the specific object B, since the player character P is located in a position hidden from the enemy character N by the specific object B, the lost-sight state can be produced without causing a user to feel unnaturality. Further, even when the player character P is not in the field of view V of the enemy character N, the lost-sight state does not occur when the imaginary line segment L connecting the enemy character N and the player character P does not touch or intersect the specific object B. Thus, it is possible to prevent frequent occurrence of lost-sight state during the battle between the player character P and the enemy character N. Therefore, a battle scene that is the most enjoyable part of an action game can be produced effectively.

Further, when the player character P enters the field of view V of the enemy character N, the position recognition determining unit (lost-sight state release determining unit) 43a releases the lost-sight state of the enemy character N and determines to change the state of the enemy character N from the lost-sight state to the position recognized state. With this configuration, reality can be imparted to a situation in which the enemy character N rediscovers the player character P in the virtual space S.

The invention is not limited to the embodiment described above. Various modified embodiments are possible without departing from the spirit and scope of the invention.

For example, in the above embodiment, the game system 1 that realizes a game in which the NPC chases the PC has been described, but the invention is applicable also to a game system that implements a game in which the NPC chases another NPC. That is, the first character that is a chased character and the second character that is the chasing character may be different NPCs, and the first character control unit 42a may function as the NPC control unit. Further, in the embodiment described above, the NPC appearing in the game implemented by the game system 1 is described as the enemy character N that battles with the player character P, but the invention is not limited to this. The NPC does not necessarily have to battle with the player character P. In this case, the NPC in the position recognized state may be set to take actions other than the battle action.

Further, the specific object B does not necessarily have to include an internal space which the player character P can enter. However, when the specific object B includes an internal space, the imaginary line segment L can reliably touch or intersect the specific object B by causing the player character P to enter the specific object B. Therefore, a situation in which the enemy character N loses sight of the player character P in the virtual space S can be created more intentionally by the user.

Although the single player character P appearing in the virtual space S has been described in the above embodiment, the game implemented by the game system 1 may be a multiplayable game in which a plurality of player characters P appears synchronously in the same virtual space S.

When a plurality of player characters P is present in the virtual space S, the trace position storing unit 44 may manage which trace positions belong to which player characters in an identifiable manner. Further, when a plurality of player characters P is present in the virtual space S, the trace position storing unit 44 may manage only positions and times without distinguishing the player characters. The trace position storing unit 44 may store and manage trace positions of all the player characters P present in the virtual space S or a part of the player characters P.

If a plurality of player characters P is present in the virtual space S, when the state of the enemy character N is changed from the position recognized state to lost-sight state, the chase processing unit 45 may cause the enemy character N to chase one player character selected from among the plurality of player characters. The player character P to be chased by the enemy character N may be a player character P selected by lottery from among the plurality of player characters P, or may be a player character P targeted by the enemy character N immediately before the enemy character N lost sight of the player character P.

Alternatively, priority as to whether the player character P is to be chased preferentially by the enemy character N may be set and managed for each player character P. In this case, a player character P having higher priority may be selected as a player character P to be chased by the enemy character N. Priority may be set and managed according to, for example, the magnitude of damage each player character P causes to the enemy character N, a level of each player character P, equipment items, current health, and the like. For example, from among a plurality of player characters P, the player character P that has caused the greatest damage to the enemy character N may be selected, or the player character P of the highest level may be selected as the player character P to be chased by the enemy character N.

### DESCRIPTION OF REFERENCE NUMERALS

41: Virtual space generating unit

40b: PC control unit

40d: NPC control unit

43a: Position recognition determining unit (lost-sight state release determining unit)

43b: Lost-sight state change determining unit

44: Trace position storing unit

45: Chase processing unit

45a: Trace position specifying unit

A: Object

B: Specific object

L: Imaginary line segment

R: Search range

S: Virtual space

V: Field of view

1. A game system comprising:
a storage unit; and
a control unit,
the control unit including
a virtual space generating unit configured to generate a virtual space;
a first character control unit configured to control an action of a first character moving in the virtual space;
a second character control unit configured to control an action of a second character moving in the virtual space;
a trace position storing unit configured to sequentially stores, in the storage unit, positions of the first character in the virtual space as trace positions at predetermined time intervals; and
a chase processing unit configured to control the second character to chase the first character based on the trace positions.

2. The game system according to claim 1, wherein:
the trace position storing unit stores, in the storage unit, the trace positions and times at which the trace positions are stored in association with each other;
an upper limit is set for the number of the trace positions stored in the storage unit; and
when the most recent trace position is to be stored in a state in which the number of already stored trace positions has reached the upper limit, the trace position storing unit deletes the trace position stored earliest among the trace positions stored in the storage unit.

3. The game system according to claim 1, wherein:
the trace position storing unit stores, in the storage unit, the trace positions and times at which the trace positions are stored in association with each other; and
the trace position storing unit deletes, from the storage unit, a trace position that has been stored in the storage unit for a certain time.

4. The game system according to claim 1, wherein:
the control unit includes a state change processing unit configured to change a state of the second character between a position recognized state in which the second character recognizes a position of the first character and a lost-sight state in which the second character does not recognize a position of the first character; and
when the state of the second character is changed from the position recognized state to the lost-sight state, the chase processing unit executes chasing of the first character by the second character based on the trace positions.

5. The game system according to claim 1, wherein:
the chase processing unit includes a trace position specifying unit configured to specify a most recently stored trace position as a target position from among the trace positions in a predetermined search range including the second character; and
the chase processing unit executes chasing of the first character by the second character by alternately repeating specifying of the trace position and movement of the second character to the specified target position.

6. The game system according to claim 5, wherein, when the trace position in the search range is not present in the trace positions stored in the storage unit, the trace position specifying unit specifies, as the target position, a predetermined trace position stored before the state is changed to the lost-sight state from among the trace positions outside the search range.

7. The game system according to claim 5, wherein, after the second character is moved to the specified trace position, when the trace position stored more recently than the trace position to which the second character is moved is not present in the search range, the trace position specifying unit specifies, as the target position, a trace position stored next recent to the previously specified trace position outside the search range.

8. A game system, comprising:
a virtual space generating unit configured to genera a virtual space in which an object is arranged;
a player character control unit configured to control an action of a blayer character moving in the virtual space in response to a user operation;
a non-player character control unit configured to control an action of a non-player character being different from the player character and moving in the virtual space; and
a lost-sight state change determining unit configured to change a state of the NPCnon-player character from a position recognition state to a lost-sight state when the object is located on an imaginary line connecting the non-player character and the player character in the virtual space,
in the position-recognition state, the non-player character recognizing a position of the player character,
in the lost-sight state, the non-player character not recognizing a position of the player character.

9. The game system according to claim 8, wherein, when the non-player character is in the position recognized state, if the imaginary line segment does not touch or intersect the specific object, the lost-sight state change determining unit keeps the NPCnon-player character in the position recognized state.

10. The game system according to claim 8, comprising a lost-sight state release determining unit that, when the player character enters a field of view of the NPCnon-player character, releases the lost-sight state of the non-player character, and determines to change the state of the NPCnon-player character from the lost-sight state to the position recognized state.

11. A method for controlling a game system, comprising:
generating a virtual space;
controlling an action of a first character moving in the virtual space;
controlling an action of a second character moving in the virtual space;
storing sequentially, in a storage unit, positions of the first character in the virtual space as trace positions at predetermined time intervals; and
controlling the second character to chase the first character based on the trace positions stored.

12. The method for controlling a game system according to claim 11, wherein
the trace position storing step stores, in the storage unit, the trace positions and times at which the trace positions are stored in association with each other;
an upper limit is set for the number of the trace positions stored in the storage unit; and
when the most recent trace position is to be stored in a state in which the number of already stored trace positions has reached the upper limit, the trace position storing step deletes the trace position stored earliest among the trace positions stored in the storage unit.

13. The method for controlling a game system according to claim 11, wherein:
the trace position storing step stores, in the storage unit, the trace positions and times at which the trace positions are stored in association with each other; and
the trace position storing step deletes, from the storage unit, a trace position that has been stored in the storage unit for a certain time.

14. The method for controlling a game system according to claim 11, comprising:
changing a state of the second character between a position recognized state in which the second character is recognizing a position of the first character and a lost-sight state in which the second character does not recognize a position of the first character, wherein
when the state of the second character is changed from the position recognized state to the lost-sight state, the chase processing step executes chasing of the first character by the second character based on the trace positions.
